(19) United States
(12) Patent Application Publication
(10) Pub. No.: US 2006/0177117 A1
(43) Pub. Date: Aug. 10, 2006

(54) Bill discrimination apparatus

(76) Inventors: Tomomitsu Morisaki, Seto (JP); Eiji Mizuno, Owariasahi (JP); Atsushi Kato, Nagoya (JP)

Correspondence Address: MCDERMOTT WILL & EMERY LLP, 600 13TH STREET, N.W., WASHINGTON, DC, 20005-3096, US

(21) Appl. No.: 11/246,546

(22) Filed: Oct. 11, 2005

(30) Foreign Application Priority Data
Feb. 8, 2005 (JP) 2005-031334

(51) Int. Cl. G06K 9/00; B07C 5/00

(52) U.S. Cl. 382/135; 382/137; 209/534

(57) ABSTRACT

In a bill discrimination apparatus including a transport path and sensors disposed on the transport path to detect a detection signal from a bill being transported through the transport path to thereby discriminate the bill, magnetic sensors having mutually different characteristics for magnetically detecting a magnetic characteristic of the bill and optical sensors for optically detecting the bill are alternately disposed on the transport path.

### BACKGROUND OF THE INVENTION

The present invention relates to a bill discrimination apparatus, and in particular, to a bill discrimination apparatus used in an-automatic tellers machine (ATM) to deposit or withdraw bills.

In the automatic tellers machine, a bill discrimination apparatus to determine denominations, genuineness, status of a bill which is damaged or undamaged, and the like is installed to discriminate bills being transported on a transport path. To discriminate a bill, it is required to detect size of the bill, reflected light from a surface of the bill, and transmitted light passed through the bill. It is also necessary to detect a magnetic characteristic of a magnetic ink used to print the bill. Therefore, optimal sensors and magnetic sensors are disposed in the bill discrimination apparatus.

For example, JP-A-9-245217 describes a technique in which line sensors, reflection/transmission sensors, and magnetic sensors are arranged in an upper unit and/or a lower unit constituting a carrier or transport path in a bill discrimination apparatus to detect information in the entire width of a bill to thereby attain higher reliability for bill discrimination.

### SUMMARY OF THE INVENTION

To cope with a problem of counterfeit or forgery of bills frequently occurring today, it is considered to increase bill genuineness discrimination capability of the bill discrimination apparatus. For this purpose, it is required to dispose an increased number of kinds of sensors in the apparatus.

When new sensors are additionally installed in the bill discrimination apparatus to increase the bill genuineness discrimination capability, it is necessary to secure compatibility of the sensors with automatic tellers machines available in the market. Therefore, the size of the bill discrimination apparatus cannot be changed. It is hence required to arranged possibly many sensors in a limited space in the apparatus.

On the other hand, when different kinds of plural magnetic sensors are arranged in the bill discrimination apparatus, interference occurs between the magnetic sensors. This leads to a problem that performance of the magnetic sensors cannot be secured. Also, when different kinds of optical sensors are arranged in the bill discrimination apparatus, interference occurs between the optical sensors as between the magnetic sensors, and hence performance of the optical sensors cannot be secured. According to analysis of the inventors of the present invention, since each of the magnetic sensors includes a magnet and a coil to generate a reference magnetic filed, a magnetic field of a magnet of a first magnetic sensor enters a second magnetic sensor. This results in an event that the second magnetic sensor cannot correctly detect a magnetic characteristic of a bill. Between the optical sensors, a noise is occurred by a propagation of lights from a first optimal sensor via a transport path to transport bills and a bill being transported through the path to a second optical sensor.

To avoid such interference, it can be considered to dispose the sensors apart from each other. However, when the magnetic sensors and the optical sensors are disposed in succession with a space therebetween to avoid interference, that is, when a plurality of sensors are arranged, there arises a problem that the bill discrimination apparatus is increased in size. Or, the apparatus cannot accommodate all the sensors desired to be disposed therein.

It is therefore an object of the present invention to provide a bill discrimination apparatus capable of preventing interference between sensors used therein while retaining the small size of the bill discrimination apparatus.

According to the present invention, there is provided a bill discrimination apparatus including a transport path and sensors disposed on the transport path for detecting a detection signal from a bill being transported through the transport path to thereby discriminate the bill. The apparatus includes a plurality of magnetic sensors for magnetically detecting the bill and a plurality of optical sensors for optically detecting the bill. The magnetic and optical sensors are alternately disposed on the transport path.

According to an favorable example of the bill discrimination apparatus, in an array of the sensors, sensors disposed on both sides of the transport path are optical sensors.

The bill discrimination apparatus favorably includes, for example, transport rollers disposed on the transport path. The rollers are driven to transport the bill in both directions including a forward direction and a reverse direction. Of optical sensors disposed respectively at both entries of the transport path for detecting entry of a bill, at least either one of the optical sensors is a sensor for obtaining information from the bill in substantially an entire width thereof.

In an example of the bill discrimination apparatus, the sensors include at least two optical sensors and at least two magnetic sensors. The optical sensors are transmission sensors. One of the magnetic sensors is a sensor for detecting a characteristic of magnetic impedance the bill and the other one thereof is a sensor for detecting a characteristic of magnetic resistance of the bill.

In another example of the bill discrimination apparatus, there are disposed transport rollers at positions opposing to the magnetic sensors.

In an example of the bill discrimination apparatus, the magnetic sensors include first magnetic sensors each for obtaining information from the bill in substantially an entire width thereof and second magnetic sensors each for obtaining information from the bill partially in a direction of the width thereof.

In a still another example of the bill discrimination apparatus, the apparatus further includes transport rollers at positions on a side of each of the second magnetic sensors.

In a favorable example, of the bill discrimination apparatus, signals detected by the optical sensors disposed on both sides of the transport path are used to cancel an offset of the magnetic or optical sensors disposed on a downstream side in the transport direction of the bill.

According to the present invention, there is provided a bill discrimination apparatus including a transport path and sensors disposed on the transport path for detecting detection signal from a bill being transported through the transport path to thereby discriminate the bill. The sensors include a plurality of magnetic sensors for magnetically detecting the bill and optical sensors for optically detecting the bill. The optical sensors being disposed between the magnetic sensors.

According to the present invention, there is proved a detection signal obtaining method for use in a bill discrimination apparatus including a transport path and sensors disposed on the transport path for detecting a detection signal from a bill being transported through the transport path to thereby discriminate the bill. The method includes the steps of obtaining a detection signal from the bill by a first optical sensor, the signal being used to cancel an offset thereof; obtaining a detection signal from the bill by a second magnetic sensor, the signal being used to detect a characteristic of magnetic impedance or a characteristic of magnetic resistance of the bill; obtaining a detection signal from the bill by a third optical sensor, the signal being used to detect a characteristic of the bill associated with a particular wavelength; and obtaining a detection signal from the bill by a second magnetic sensor, the signal being used to detect a characteristic of magnetic resistance or a characteristic of magnetic impedance of the bill.

Other objects, features and advantages of the invention will become apparent from the following description of the embodiments of the invention taken in conjunction with the accompanying drawings.

### BRIEF DESCRIPTION OF THE DRAWINGS

FIG. 1 is a side view of an embodiment (first embodiment) of a bill discrimination apparatus according to the present invention.

FIG. 2 is a plan view of the apparatus of FIG. 1 viewed from an upper side thereof.

FIG. 3 is a side view of an embodiment (second embodiment) of a bill discrimination apparatus according to the present invention.

FIG. 4 is a plan view of the apparatus of FIG. 3 viewed from an upper side thereof.

FIG. 5 is a flowchart to explain operation to control sensor initialization in an embodiment.

FIG. 6 is a flowchart to explain operation to control sensor initialization in an embodiment.

### DESCRIPTION OF THE EMBODIMENTS

Description will now be given in detail of embodiments of the present invention by referring to the drawings. However, the present invention is not restricted by the embodiments.

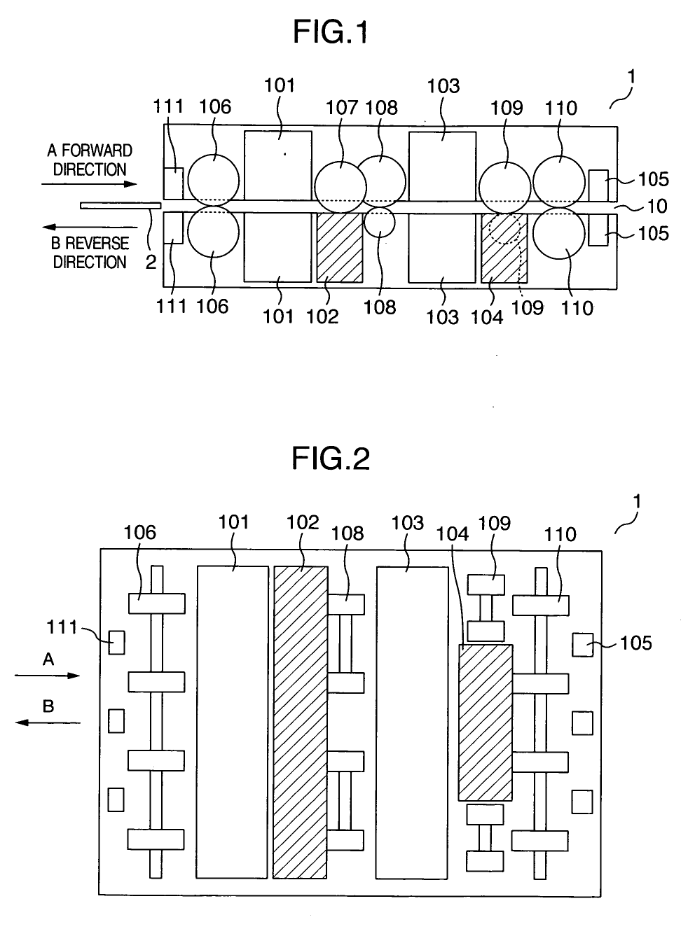

FIG. 1 is a side view of a bill discrimination apparatus according to the present invention and FIG. 2 is a plan view of the apparatus. On a transport or carrier path 10 of a bill discrimination apparatus 1, a plurality of rollers 106 to 110 are arranged. Rotation of the transport rollers is controlled by control signals from a controller (not shown) to transport a bill in both directions, i.e., forward direction A and reverse direction B. In this example of the bill discrimination apparatus in which a bill is transported in the forward and reverse directions, information obtained from the bill in the transportation of the bill respectively in forward direction A and reverse direction B is processed to determine, for example, the denomination of the bill, genuineness thereof, and a state thereof which is damaged or undamaged. For the bill discrimination, a processor (not shown) installed in the controller processes signals sensed by various sensors, which will be described later. The processor carried out processing by executing, for example, a program to obtain data sensed by the sensors and a program to determine by use of the data the denomination of the bill, genuineness thereof, and a state thereof which is damaged or undamaged.

To obtain various sense or detection signals from the bill, optical sensors 101 and 103 and magnetic sensors 102 and 104 are disposed on the transport path 10. According to one aspect of the apparatus 1, to prevent interference between the magnetic sensors 102 and 104 and between the optical sensors 101 and 103, the magnetic and optical sensors are alternately arranged with a predetermined distance secured in the interval between the magnetic sensors 102 and 104 and between the optical sensors 101 and 103. That is, between the magnetic sensors 102 and 104, an optical sensor not exerting influence onto the sensors is installed to suppress interference between the sensors and the installation space is thereby efficiently used to reduce the overall size of the bill discrimination apparatus.

Description will be given of an example of characteristics and functions of the sensors installed in the bill discrimination apparatus. The optical sensor 101 is a reflection/transmission sensor capable of sensing information in the entire surface of a bill. The optical sensor 103 is a transmission sensor to detect or to sense a characteristic of the bill associated with a particular wavelength. The magnetic sensor 102 is a sensor to detect a magnetic impedance characteristic of the bill. The magnetic sensor 104 is a sensor to detect a magnetic resistance characteristic of the bill. The optical sensors 101 and 103 and the magnetic sensor 102 are sensors of line sensor type to entirely cover width of the transport path 10 to detect respective signals from the bill being transported through the path 10 in the entire width of the bill.

In the bill discrimination apparatus of FIG. 1 in which a bill is transported in forward direction A and reverse direction B, it is required to initialize the magnetic sensor 102, the optical sensor 103, and the magnetic sensor 104 to cancel an offset thereof before a bill arrives at each of the sensors such that the sensor produces an output at a fixed output level. For this purpose, entry detection sensors 105 and 111 are disposed on both sides of the transport path 10 to detect entry of a bill. The entry detection sensors 105 and 111 are optical sensors.

In this embodiment, to minimize the sill discrimination apparatus in size, consideration has been given to a relationship between positions at which the transport rollers and the sensors are disposed. For example, when the required sensors are simply installed between the transport rollers, the transport path is elongated and a wide installation space is required. To overcome this difficulty, transport rollers 107 and 109 are arranged respectively on opposing surfaces respectively of the magnetic sensors 102 and 104 in the present embodiment to push the bill onto each of the magnetic sensors 102 and 104. This provides medium transport capability to transport a medium such as a bill. Any transport roller is not disposed between the optimal sensor 101 and the magnetic sensor 102 and between the optimal sensor 103 and the magnetic sensor 104. On both sides of the optimal sensor 101 and the magnetic sensor 102, transport rollers 106 and 108 are arranged. On both sides of the optimal sensor 103 and the magnetic sensor 104, transport rollers 108 and 110 are arranged. This resultantly reduces interference between the sensors while keeping the medium transport capability to transport a medium such as a bill. Therefore, the sensors and the rollers can be mounted in a limited space. Since the optical sensors 101, 103, 105, and 111 are transmission sensors, any transport roller is not installed at positions opposing to the rollers.

In this example, the magnetic sensor 104 is disposed to detect a security thread of a bill and hence is not required to exist in the entire width of the bill. It is only necessary that the detection range of the magnetic sensor 104 is a range through which the security thread passes. Therefore, the transport rollers 109 can be additionally installed in a free space as shown in FIG. 2 and hence the medium transport capability of the apparatus is increased.

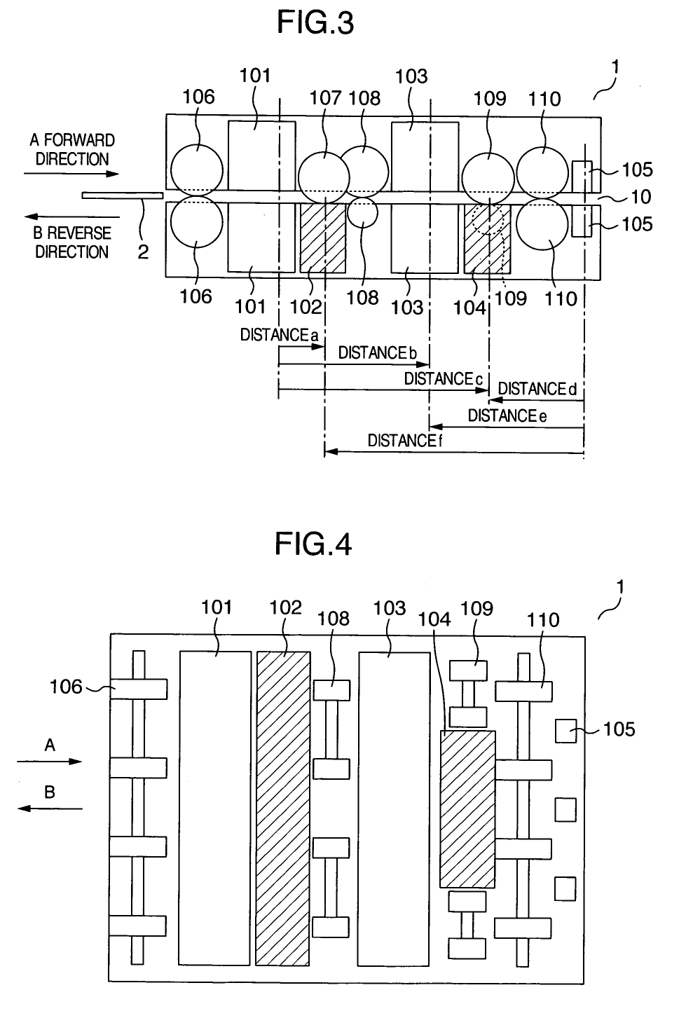

Next, another embodiment (a second embodiment) will be described by referring to FIGS. 3 and 4. In this example, the entry detection sensor 111 of the first embodiment is removed, and the optical sensor 101 also conducts the function of the entry detection sensor 111. In these diagrams, the constituent components as those of FIGS. 1 and 2 are assigned with the same reference numerals.

In the bill discrimination apparatus in which the bill is transported in the forward direction and reverse directions, to conduct the initialization for the offset cancellation before the bill arrives at an associated sensor, the entry detection sensors 105 and 111 are disposed on both sides of the transport path of the bill discrimination apparatus. In the example of FIG. 1, the optical sensors 111 and 101 are sequentially or successively disposed in the bill transportation path in forward direction A. In the example of FIGS. 3 and 4, the optical sensor 111 is removed and the optical sensor 101 also conducts the function of the removed sensor 111.

On the other hand, the optical sensor 105 in the transportation of the bill in reverse direction B cannot be removed for the following reason. If the bill first passes through the magnetic sensor 104 in the transportation of the bill in reverse direction B, it will be required for the magnetic sensor 104 to detect entry of the bill. However, to detect entry of the bill, it is required for the magnetic sensor 104 to detect a magnetic characteristic in an entire surface of the bill. However, actually, there does not exist such bill having a magnetic characteristic in the overall surface of the bill. Therefore, it is impossible to remove the entry detection sensor 105 disposed on an entry side in the bill transportation in reverse direction B.

As above, the entry detection sensor 111 in the forward-directional transportation of the bill is removed and the function of the sensor 111 is carried out by the optical sensor 101 of line type to resultantly further reduce the size of the bill discrimination apparatus.

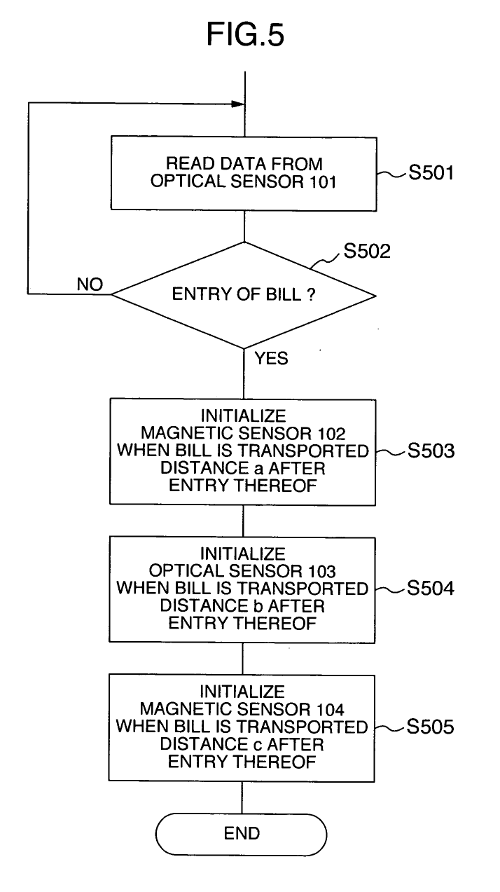

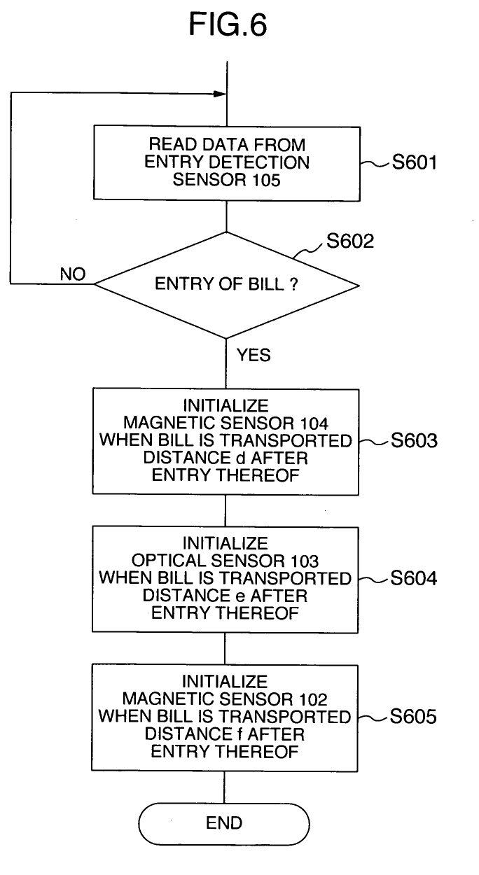

Referring now to FIGS. 5 and 6, description will be given of the initialization such as offset cancellation in the second embodiment of the bill discrimination apparatus.

Although the sensor initialization itself is not directly related to the gist of the present invention, the sensor initialization will be described for the following reason. It is important in the example of the bill discrimination apparatus which transports a bill in both directions that the sensors arranged on both sides of the transportation path 10 are optical sensors and hence the initialization can be conducted.

In the bill discrimination apparatus shown in FIG. 3, for each bill, it is required to conduct offset cancellation for the magnetic sensor 102, the optical sensor 103, and the magnetic sensor 104. For each sensor, it is necessary that the initialization is conducted before the bill arrives at the sensor.

In the bill discrimination apparatus in which the bill is transported in both directions, the sensor 101 or 105 at the entry in the bill transportation direction detects a bill. In FIG. 3, letters a to f indicate distances from the entry detection sensor 101 or 105 respectively to sensors to be initialized. In forward direction A, the distance between the optical sensor 101 and the magnetic sensor 102 is a, the distance between the optical sensor 101 and the optical sensor 103 is b, and the distance between the optical sensor 101 and the magnetic sensor 104 is c. In reverse direction B, the distances between the optical sensor 105 to the respective sensors 104, 103, and 102 are d, e, and f, respectively. After detecting entry of a bill, each of the sensors is initialized when the bill is transported the distance associated with the sensor.

FIG. 5 is a flowchart of the sensor initialization in the bill transportation in forward direction A and FIG. 6 is a flowchart of the sensor initialization in reverse direction B. The flowcharts are substantially equal in the processing to each other, but differ from each other only in the detection sensor (101, 105). Therefore, as a representative example, the initialization of the respective sensors in forward direction A will be described by referring to FIG. 5.

In FIG. 5, the controller reads a sense or detection signal from the optical sensor 101 (S501) to determine presence or absence of entry of a bill (S502). If entry of a bill is determined, the controller calculates a period of time equivalent to distance a to initialize the magnetic sensor 102 within the period of time (S503). The controller then calculates a period of time equivalent to distance b to initialize the optical sensor 103 within the period of time (S504). Thereafter, the controller calculates a period of time equivalent to distance c to similarly initialize the magnetic sensor 104 within the period of time (S505). After conducting the operation for the sensors in this way, the controller terminates processing to initialize the associated sensors.

Although description has been given of two embodiments as above, the present invention is not restricted by the embodiments, but can be modified without departing from the spirit and scope of thereof.

For example, in the arrangement of various sensors in the bill discrimination apparatuses shown in FIGS. 1 to 4, it is also possible that reflection sensors are used in place of transmission sensors for the optical sensors or transmission sensors and reflection sensors are used as the optical sensors.

Also, the relationship between the installation positions of the sensors and those of transport rollers is not restricted by the embodiments. For example, if the bill discrimination apparatus has a sufficient free space, it may be possible that the transportation rollers are disposed at positions other than those opposing to the magnetic sensors.

The bills to which the present invention is applicable include not only the bank notes of Japan but also the bank notes of china, the bank notes (Euro) of European Union, and the like.

According to the present invention, it is possible to increase the number of kinds of sensors which can be efficiently arranged while preventing interference between the sensors. Therefore, the bill discrimination apparatus is reduced in size. When compared with the prior art, a larger number of kinds of sensors can be mounted in the bill discrimination apparatus and hence the capability of discriminating genuineness of bills is increased.

It should be further understood by those skilled in the art that although the foregoing description has been made on embodiments of the invention, the invention is not limited thereto and various changes and modifications may be made without departing from the spirit of the invention and the scope of the appended claims.

1. A bill discrimination apparatus discriminating a bill by sensors disposed on the transport path for detecting a detection signal from a bill being transported through the transport path, the bill discrimination apparatus comprising:
a plurality of magnetic sensors for magnetically detecting the bill; and
a plurality of optical sensors for optically detecting the bill, wherein the magnetic and optical sensors are alternately disposed on the transport path.

2. The bill discrimination apparatus according to claim 1, wherein in an array of the sensors, sensors disposed on both sides of the transport path are optical sensors.

3. The bill discrimination apparatus according to claim 1, further comprising transport rollers disposed on the transport path, wherein:
the rollers are driven to transport the bill in both directions including a forward direction and a reverse direction;
of optical sensors disposed respectively at both entries of the transport path for detecting entry of a bill, at least either one of the optical sensors is a sensor for obtaining information from the bill in substantially an entire width thereof.

4. The bill discrimination apparatus according to claim 1, wherein:
the sensors include at least two optical sensors and at least two magnetic sensors, the optical sensors being transmission sensors;
one of the magnetic sensors is a sensor for detecting a characteristic of magnetic impedance of the bill; and
other one thereof is a sensor for detecting a characteristic of magnetic resistance of the bill.

5. The bill discrimination apparatus according to claim 1, further comprising transport rollers at positions opposing to the magnetic sensors.

6. The bill discrimination apparatus according to claim 1, wherein:
the magnetic sensors include first magnetic sensors each for obtaining information from the bill in substantially an entire width thereof and second magnetic sensors each for obtaining information from the bill partially in a direction of the width thereof.

7. The bill discrimination apparatus according to claim 6, further comprising transport rollers at positions on a side of each of the second magnetic sensors.

8. The bill discrimination apparatus according to claim 2, signals detected by the optical sensors disposed on both sides of the transport path are used to cancel an offset of the magnetic or optical sensors disposed on a downstream side in the transport direction of the bill.

9. A bill discrimination apparatus discriminating a bill by sensors disposed on the transport path for detecting a detection signal from a bill being transported through the transport path, the bill discrimination apparatus comprising:
a plurality of magnetic sensors for magnetically detecting the bill; and
optical sensors for optically detecting the bill, the optical sensors being disposed between the magnetic sensors.

10. A detection signal obtaining method for use in a bill discrimination apparatus discriminating a bill by sensors disposed on the transport path for detecting a detection signal from a bill being transported through the transport path, the detection signal obtaining method comprising the steps of:
obtaining a detection signal from the bill by a first optical sensor, the signal being used to cancel an offset of the first optical sensor;
obtaining a detection signal from the bill by a second magnetic sensor, the signal being used to detect a characteristic of magnetic impedance or a characteristic of magnetic resistance of the bill;
obtaining a detection signal from the bill by a third optical sensor, the signal being used to detect a characteristic of the bill associated with a particular wavelength; and
obtaining a detection signal from the bill by a second magnetic sensor, the signal being used to detect a characteristic of magnetic resistance or a characteristic of magnetic impedance of the bill.
